(19) United States
(12) Patent Application Publication
(10) Pub. No.: US 2017/0301053 A1
(43) Pub. Date: Oct. 19, 2017

(54) OPERATION PLANNING METHOD, OPERATION PLANNING APPARATUS, OPERATION PLANNING SYSTEM, AND COMPUTER-READABLE RECORDING MEDIUM

(71) Applicants: FUJITSU LIMITED, Kawasaki-shi (JP); KYUSHU UNIVERSITY, NATIONAL UNIVERSITY CORPORATION, Fukuoka-shi (JP)

(72) Inventors: Hirokazu Anai, Hachioji (JP); Kotaro Ohori, Sumida (JP); Hidenao Iwane, Kawasaki (JP); Naoyuki Kamiyama, Fukuoka (JP); Akafumi Kira, Fukuoka (JP)

(73) Assignees: FUJITSU LIMITED, Kawasaki-shi (JP); KYUSHU UNIVERSITY, NATIONAL UNIVERSITY CORPORATION, Fukuoka-shi (JP)

(21) Appl. No.: 15/485,591

(22) Filed: Apr. 12, 2017

(30) Foreign Application Priority Data
Apr. 14, 2016 (JP) 2016-081319

(51) Int. Cl. G06Q 50/30; G06Q 10/06; G06F 17/30

(52) U.S. Cl. CPC G06Q 50/30; G06F 17/30946; G06Q 10/06315

(57) ABSTRACT

A non-transitory computer-readable recording medium stores an operation planning program that causes a computer to execute a process including: for a set including elements that are users, for which a plan of operation including ride sharing is to be generated, performing ordering of the elements of the set by using indices indicating highness of possibilities that subadditivity is fulfilled, determining whether a combination of the elements in descending order of the ordering fulfills the subadditivity, the number of the elements in the combination being equal to or less than a predetermined number, and partitioning the set into subsets, for which the ride sharing is to be operated, by adding the combination of elements fulfilling the subadditivity to the subsets; and generating the plan of operation by using the partitioned subsets.

### CROSS-REFERENCE TO RELATED APPLICATION

This application is based upon and claims the benefit of priority of the prior Japanese Patent Application No. 2016-081319, filed on Apr. 14, 2016, the entire contents of which are incorporated herein by reference.

### FIELD

The embodiments discussed herein are related to an operation planning program, an operation planning method, an operation planning apparatus, and an operation planning system.

### BACKGROUND

In recent years, there have been regions where a sufficient number of taxis and buses are unable to be in operation due to generation of loss-making lines because of declining population. Thus, for a moving means, such as a taxi, for example, ride sharing operation, where plural users share the taxi by bearing the fare together, has been proposed. Further, a technique, which is for forming a plan of operation that goes through a start point and an arrival point of each user by regarding the problem in such ride sharing operation as a vehicle routing problem, has been proposed (as disclosed in Japanese Laid-open Patent Publication No. 03-37761, Japanese Laid-open Patent Publication No. 2004-280734, and Japanese Laid-open Patent Publication No. 2001-34881, for example).

However, for the vehicle routing problem, when the number of users to share the taxi is increased, the amount of calculation is increased, and a strict solution may be unable to be obtained. Further, when the problem is regarded as the vehicle routing problem, the problem turns out to be optimization from a standpoint of the management company, such as the taxi company, and thus the quality (subadditivity) that the fare does not become more expensive than that in a case where each user uses a taxi alone may be unable to be fulfilled.

### SUMMARY

According to an aspect of the embodiments, a non-transitory computer-readable recording medium stores an operation planning program that causes a computer to execute a process including: for a set including elements that are users, for which a plan of operation including ride sharing is to be generated, performing ordering of the elements of the set by using indices indicating highness of possibilities that subadditivity is fulfilled, determining whether a combination of the elements in descending order of the ordering fulfills the subadditivity, the number of the elements in the combination being equal to or less than a predetermined number, and partitioning the set into subsets, for which the ride sharing is to be operated, by adding the combination of elements fulfilling the subadditivity to the subsets; and generating the plan of operation by using the partitioned subsets.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a schematic configuration of a system;

FIG. 2 is a diagram schematically illustrating a functional configuration of an operation planning apparatus;

FIG. 3 is a diagram illustrating an example of a data configuration of customer information;

FIG. 4 is a diagram illustrating an example of a data configuration of a cost database;

FIG. 5 is a diagram illustrating an example of a registration screen;

FIG. 6 is a diagram illustrating an example of directional branches;

FIG. 7 is a diagram illustrating an example of an operation plan screen;

FIG. 8 is a flow chart illustrating an example of a procedure of a partitioning process;

FIG. 9 is a flow chart illustrating an example of a procedure of a subset search process;

FIG. 10 is a flow chart illustrating an example of a procedure of a determination process;

FIG. 11 is a flow chart illustrating an example of a procedure of a partitioning process to be compared;

FIG. 12 is a flow chart illustrating an example of a procedure of a deletion process;

FIG. 13 is a flow chart illustrating another example of the procedure of the deletion process;

FIG. 14A is a diagram illustrating a specific example;

FIG. 14B is a diagram illustrating the specific example;

FIG. 15A is a diagram illustrating another specific example;

FIG. 15B is a diagram illustrating the other specific example; and

FIG. 16 is a diagram illustrating an example of a configuration of a computer that executes an operation planning program.

### DESCRIPTION OF EMBODIMENTS

Preferred embodiments will be explained with reference to accompanying drawings. The disclosed techniques are not limited by these embodiments. Further, the following embodiments may be combined with one another as appropriate so long as no contradiction is caused thereby.

### [a] First Embodiment

System Configuration

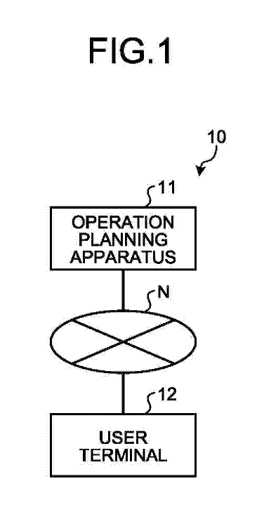

An example of an operation planning system according to a first embodiment will be described. FIG. 1 is a diagram illustrating an example of a schematic configuration of the system. An operation planning system 10 has an operation planning apparatus 11, and a user terminal 12. The operation planning apparatus 11 and the user terminal 12 are connected communicatably to a network N. A communication network of any type, such as: a communication network for moving bodies, such as portable telephones; the Internet; a local area network (LAN); or a virtual private network (VPN), may be adopted as one mode of the network N, regardless of whether the communication network is wired or wireless. FIG. 1 illustrates, as an example, a case where the single user terminal 12 is provided, but not being limited to this example, the system may have any number of user terminals 12.

The operation planning apparatus 11 is an apparatus that generates an operation plan for ride sharing where plural users share together a single vehicle. For example, the operation planning apparatus 11 is a computer, such as a server computer. The operation planning apparatus 11 may be implemented as a single computer, or may be implemented by plural computers. In this embodiment, a case where the operation planning apparatus 11 is implemented as a single computer will be described as an example. In this embodiment, a case, where the operation planning apparatus 11 generates an operation plan for ride sharing operation of a vehicle, which is, for example, a jumbo taxi allowing about ten people onboard, will be described as an example. In this embodiment, the operation planning apparatus 11 provides service for sharing a taxi, and in response to a request from the user terminal 12, transmits screen information on various screens to a request source, causes the request source to display the screens, and receives input of various pieces of information through the screens.

The user terminal 12 is an apparatus used by a user who uses the ride sharing service provided by the operation planning apparatus 11. For example, the user terminal 12 is an information processing apparatus, such as a personal computer, a smartphone, or a tablet terminal, which is used by the user.

Configuration of Operation Planning Apparatus

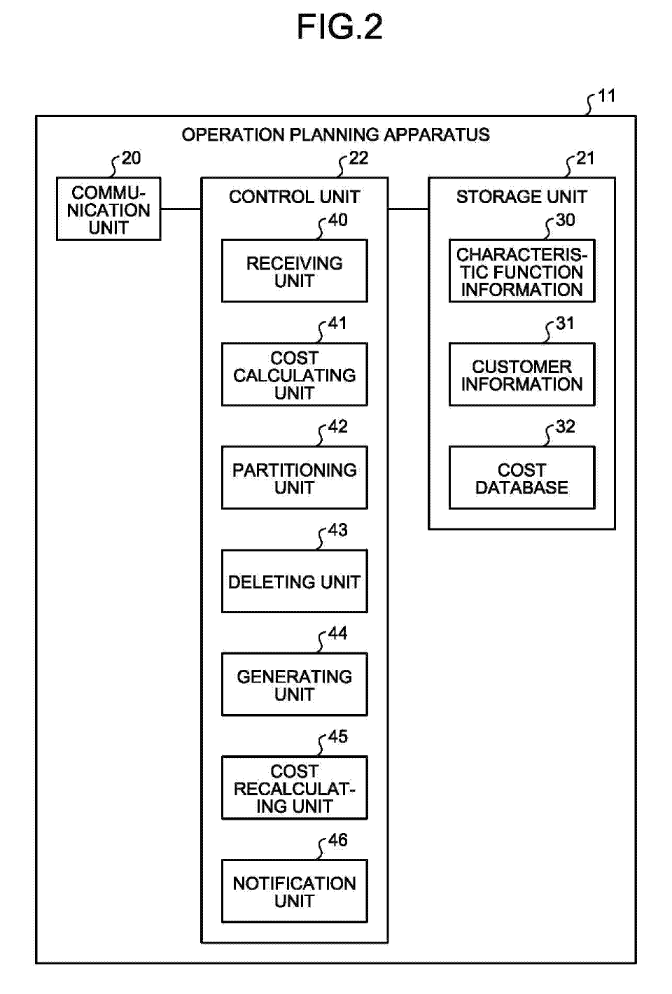

Next, a configuration of the operation planning apparatus 11 will be described. FIG. 2 is a diagram schematically illustrating a functional configuration of the operation planning apparatus. The operation planning apparatus 11 illustrated in FIG. 2 has a communication unit 20, a storage unit 21, and a control unit 22.

The communication unit 20 is a communication interface that performs wireless communication or wired communication with the network N. For example, the communication unit 20 receives, from the user terminal 12, a request for access to the ride sharing service. Further, for example, the communication unit 20 transmits, to the user terminal 12, from which the request for the access has been received, screen information on various screens for the ride sharing service.

The storage unit 21 is a storage device, such as a hard disk, a solid state drive (SSD), or an optical disk. The storage unit 21 may be a data-rewritable semiconductor memory, such as a random access memory (RAM), a flash memory, or a non-volatile static random access memory (NVSRAM). The storage unit 21 stores therein an operating system (OS) executed by the control unit 22, and various programs for execution of various processes described later. Further, the storage unit 21 stores therein various pieces of information. For example, the storage unit 21 stores therein characteristic function information 30, customer information 31, and a cost database 32. The storage unit 21 may store therein any other various pieces of information. For example, the storage unit 21 stores therein master information, such as a user identification (ID) and a password of each user, for authentication of users that are able to use the ride sharing service.

The characteristic function information 30 is data including various pieces of information related to a characteristic function used in calculation of a cost. In this embodiment, a cost and a route of ride sharing are calculated as a traveling salesman problem (TSP). The characteristic function information 30 includes a characteristic function and constraint conditions, for the traveling salesman problem. Details of the characteristic function and constraint conditions will be described later.

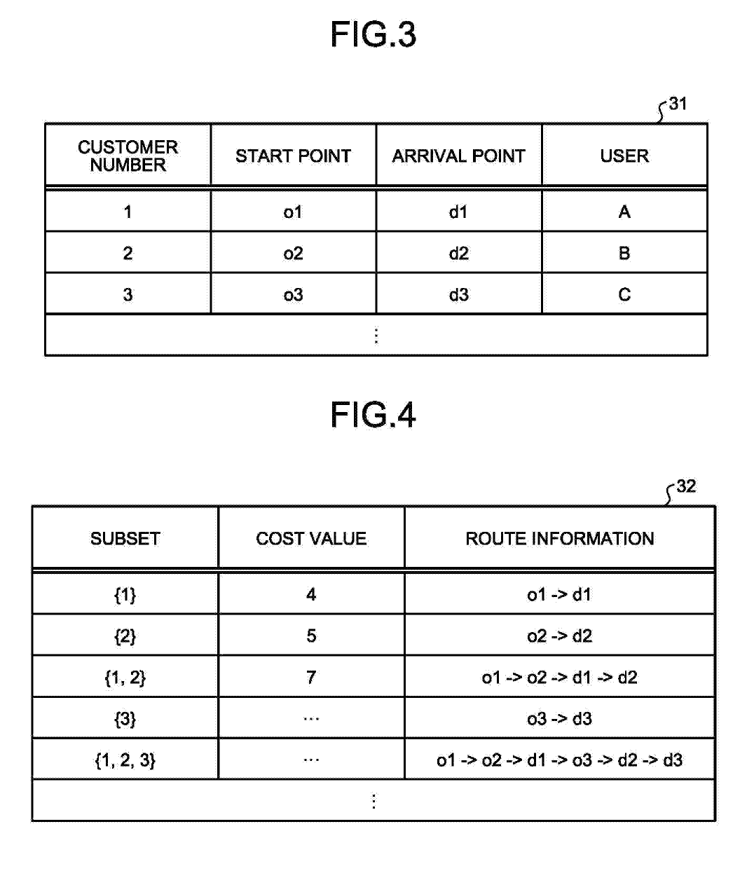

The customer information 31 is data including various pieces of information related to a user, from which a request for ride sharing has been received. In this embodiment, the customer information 31 includes information on a departure place and a destination of the user, from which the request for ride sharing has been received. FIG. 3 is a diagram illustrating an example of a data configuration of the customer information. As illustrated in FIG. 3, the customer information 31 has respective items, including “customer number”, “start point”, “arrival point”, and “user”. The customer information 31 may include, in addition to those mentioned above, various pieces of information related to attributes of the users.

The item, “customer number”, is an area storing therein identification information for identifying users, from which requests for ride sharing have been received. As the identification information, unique customer numbers are given to the users in the order, in which their requests have been received, for example. In this embodiment, for each day, on which ride sharing operation is performed, unique customer numbers are given in the order, in which the requests have been received. In the item, “customer number”, the customer numbers given to the users are stored. The item, “start point”, is an area storing therein start points requested by the users of the customer numbers. The item, “arrival point”, is an area storing therein arrival points requested by the users of the customer numbers. In this embodiment, start points are denoted by a character, “o”, and arrival points by a character, “d”, but practically, positional information indicating positions of the start points and arrival points is stored. The item, “user”, is an area storing therein the users who have requested ride sharing.

The example in FIG. 3 illustrates that a user of a customer number, “1”, has requested a start point, “o1”, has requested an arrival point, “d1”, and that this user who has requested ride sharing is “A”.

As illustrated in FIG. 2, the cost database 32 is data including various pieces of information related to a cost for each subset partitioned from a set having users as elements thereof, the users having requested ride sharing. FIG. 4 is a diagram illustrating an example of a data configuration of the cost database. As illustrated in FIG. 4, the cost database 32 has items including “subset”, “cost value”, and “route information”. The cost database 32 may include, in addition to those mentioned above, various pieces of information related to the attributes and arrival times of the users.

The item, “subset”, is an area storing therein elements included in each subset. In the example of FIG. 4, elements included in each subset are indicated by customer numbers. The item, “cost value”, is an area storing therein a cost of operation where users corresponding to elements included in each subset share a ride. When the number of elements included in a subset is one, the cost of the operation becomes a cost of operation for a user alone corresponding to the element. The item, “route information”, is an area storing therein a route for operation where users corresponding to elements included in each subset share a ride.

The example of FIG. 4 illustrates that: a subset, “{1}”, includes the customer number, “1”; a route therefor is “start point o1→arrival point d1”; and a cost of the route is “4”. Further, the example illustrates that: a subset, “{1, 2}”, includes the customer number, “1”, and a customer number, “2”; a route therefor is “start point o1→start point o2→arrival point d1→arrival point d2”; and a cost of the route is “7”.

As illustrated in FIG. 2, the control unit 22 is a device that controls the whole operation planning apparatus 11. As the control unit 22, an electronic circuit, such as a central processing unit (CPU) or a micro processing unit (MPU), or an integrated circuit, such as an application specific integrated circuit (ASIC) or a field programmable gate array (FPGA), may be adopted. The control unit 22 has an internal memory for storing therein a program, which prescribes various processing procedures, and control data, and the control unit 22 executes various processes by using them. The control unit 22 functions as various processing units by various programs being operated. For example, the control unit 22 has a receiving unit 40, a cost calculating unit 41, a partitioning unit 42, a deleting unit 43, a generating unit 44, a cost recalculating unit 45, and a notification unit 46.

The receiving unit 40 receives various operations. For example, when the receiving unit 40 receives access from the user terminal 12, the receiving unit 40 causes the user terminal 12 of an access source to display various operation screens by transmitting information on the various operation screens to the access source, and receives various operations through the operation screens. For example, the receiving unit 40 provides a Web site for ride sharing service. When the receiving unit 40 receives access to the Web site for ride sharing service from the user terminal 12, the receiving unit 40 causes the user terminal 12 of an access source to display a login screen by transmitting information on the login screen to the user terminal 12, and receives a login operation through input of a login ID and a password. When the receiving unit 40 receives the login operation, the receiving unit 40 executes authentication by comparing the input login ID and password with a login ID and a password that have been registered in advance. If the input login ID and password have been determined to be right by the authentication, the receiving unit 40 causes the user terminal 12 of the access source to display a registration screen for registration of a start point and an arrival point of the user by transmitting information on the registration screen to the user terminal 12, and receives registration of the start point and arrival point of the user.

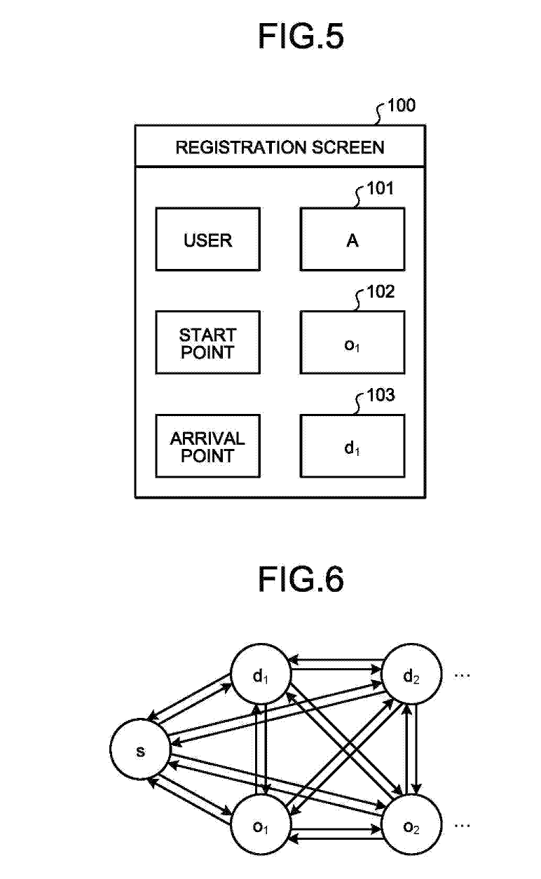

FIG. 5 is a diagram illustrating an example of the registration screen. The example in FIG. 5 illustrates an example of the registration screen displayed on the user terminal 12. A registration screen 100 has: a user name display area 101, in which a user name is displayed; a start point specification area 102, in which a start point is specified; and an arrival point specification area 103, in which an arrival point is specified. A user desiring ride sharing operation specifies a start point and an arrival point by using the registration screen 100 on a day before a desired date of ride sharing. The receiving unit 40 stores the start point, arrival point, and user name specified on the registration screen 100, into the customer information 31, in association with a customer number of the user.

The cost calculating unit 41 receives specification of a subset and an instruction for calculation, from the partitioning unit 42. When the subset is specified and the calculation is instructed, the cost calculating unit 41 calculates a cost and a route for when operation where users of elements included in the specified subset share a ride is performed, by using various pieces of information related to a characteristic function used in calculation of the cost, the characteristic function having been stored in the characteristic function information 30. In this embodiment, the cost and route for the ride sharing is calculated as a traveling salesman problem.

For example, it will now be assumed that a subset X of |X| users has been specified. It will also be assumed that for a user, “i”, the start point is “oi”, and the arrival point is “di”. Further, for example, it will be assumed that the first start point (depot) of the taxi, such as the position of the taxi company, is “s”. A set of these points will be denoted as vertices, P(X)={s}∪{oi, di|iεX}, and directional branches among these points will be denoted as A(X) as expressed by Expression (1) below. The cost calculating unit 41 finds directional branches joining these points, which are the start point, “oi”, and the arrival point, “di”, of each user, and the depot, “s”, to one another.

A(X):={(p,q)|p,qεP(X) such that p≠q}, (1)

A directional branch, “(p, q)”, represents “roads or a route” from a point, “p”, to a point, “q”. Further, for a directional branch, “(p, q)”, δ((p, q))=p, and ρ((p, q))=q. That is, “δ((p, q))” represents a start point of the directional branch, “(p, q)”; and “ρ((p, q))” represents an end point of the directional branch, “(p, q)”.

Further, in order to calculate a cost, a weight value indicating “cost” is determined for the directional branch. For example, if the cost is determined according to the distance, the distance from the point, “p”, to the point, “q”, is used as the weight of the directional branch, “(p, q)”. For example, the weight of a directional branch, “a”, is denoted by “d(a)”.

FIG. 6 is a diagram illustrating an example of directional branches. The example in FIG. 6 illustrates an example of directional branches of “o1”, “o2”, “d1”, “d2”, and “s”. As the weight of a directional branch, “(o1, d1)”, from “o1” to “d1”, the distance from the point, “p”, to the point, “q”, is used.

Further, variables are defined as described below. A variable, “x(a)”, is “1” when the directional branch, “a”, is used as the route, and is “0” when the directional branch, “a”, is not used as the route. A variable, “y(a)”, is a variable corresponding to an ordering sequence number of the directional branch, “a”, in the order in which the directional branches are passed in the route. In this embodiment, the ordering sequence numbers indicate the order in which the directional branches are passed, by “(the number of vertices)−1” being sequentially decremented by “1”. That is, in this embodiment, the initial value of the ordering sequence number is “(the number of vertices)−1”, and the larger the value of the ordering sequence number is, the earlier the directional branch is passed in the order. A variable, “z(a)”, is a variable indicating the number of passengers for the directional branch, “a”.

The cost of the route is the total of weights of the directional branches used in the route (=Σd(a)×x(a)).

The cost calculating unit 41 solves a traveling salesman problem by calculating a route, by which the cost is minimized, as expressed by Expression (2) below, under constraint conditions expressed by Conditions (3) to (6) below.

$$min {\sum }_{a ∈ A ( X )}^{ } d ( a ) \cdot x ( a ) \\ s . t . ( 3 ) , ( 4 ) , ( 5 ) , and ( 6 ) \\ x ∈ {\{ 0 , 1 \}}^{A ( X )} , y , z ∈ {R}_{+}^{A ( X )} . \qquad ( 2 )$$

Conditions (3) to (6) will now be described.

Condition (3) is expressed by Expressions (3-1) and (3-2) below.

$$\begin{matrix}{\sum }_{a ∈ δ ( υ )}^{ } x ( a ) = 1 … ( 3 - 1 ) & and \\ {\sum }_{a ∈ ρ ( υ )}^{ } x ( a ) = 1 … ( 3 - 2 ) & ( υ ∈ P ( X ) ) . \end{matrix} \} \qquad ( 3 )$$

Expression (3-1) indicates that each of the points has a single directional branch that goes out from that point. Expression (3-2) defines that each of the points has a single directional branch that goes into that point. That is, Condition (3) defines that each point in the route is passed only once.

Condition (4) is expressed by Expressions (4-1), (4-2), and (4-3) below.

$$\begin{matrix}y ( a ) \leq ( \vert P ( X ) \vert - 1 ) \cdot x ( a ) & ( a ∈ A ( X ) ) … ( 4 - 1 ) \\ {\sum }_{a ∈ δ ( s )}^{ } y ( a ) = \vert P ( X ) \vert - 1 & … ( 4 - 2 ) \\ {\sum }_{a ∈ ρ ( υ )}^{ } y ( a ) - {\sum }_{a ∈ δ ( υ )}^{ } y ( a ) = 1 & ( υ ∈ P ( X ) \backslash \{ s \} ) . … ( 4 - 3 )\end{matrix} \} \qquad ( 4 )$$

Expression (4-1) defines that “y(a)” becomes positive only when the directional branch is used as the route. Expression (4-2) defines that “y(a)” is “|P(X)|−1” when the vehicle starts the first start point (depot), “s”. Expression (4-3) defines that “y(a)” is decremented by “1” when a point is passed. That is, Condition (4) defines that the points in the route are determined in order.

Condition (5) is expressed below.

$${\sum }_{a ∈ δ ( {o}_{i} )}^{ } y ( a ) \geq {\sum }_{a ∈ δ ( {d}_{i} )}^{ } y ( a ) ( i ∈ X ) . \qquad ( 5 )$$

Condition (5) defines that the value of “y(a)” for the directional branch, “a”, having the start point, “oi”, as the start point, is larger than the value of “y(a)” for the directional branch, “a”, having the start point, “di”, as the start point. That is, Condition (5) defines that an arrival point is passed later than a start point.

The condition (6) is expressed by Expressions (6-1), (6-2), (6-3), (6-4), and (6-5) below.

$$\begin{matrix}z ( a ) \leq \vert X \vert \cdot x ( a ) & ( a ∈ A ( X ) ) … ( 6 - 1 ) \\ {\sum }_{a ∈ δ ( s )}^{ } z ( a ) = 0 & … ( 6 - 2 ) \\ {\sum }_{a ∈ ρ ( {o}_{i} )}^{ } z ( a ) - {\sum }_{a ∈ δ ( {o}_{i} )}^{ } z ( a ) = - 1 & ( i ∈ X ) … ( 6 - 3 ) \\ {\sum }_{a ∈ ρ ( {d}_{i} )}^{ } z ( a ) - {\sum }_{a ∈ δ ( {d}_{i} )}^{ } z ( a ) = 1 & ( i ∈ X ) … ( 6 - 4 ) \\ {\sum }_{a ∈ δ ( {d}_{i} )}^{ } z ( a ) \geq 1 - x ( ( {d}_{i} . s ) ) & ( i ∈ X ) … ( 6 - 5 )\end{matrix} \} \qquad ( 6 )$$

Expression (6-1) defines that “z(a)” becomes positive only when the directional branch, “a”, is used. Expression (6-2) defines that the number of passengers is “0” when the vehicle starts the first start point (depot), “s”. Expression (6-3) defines that the number of passengers is incremented by “1” when the vehicle passes a point that is a start point. Expression (6-4) defines that the number of passengers is decremented by “1” when the vehicle passes a point that is an arrival point. Expression (6-5) defines that for the arrival point, “di”, heading for the start point (depot), “s”, the right side of the expression becomes “1”, except for when a user is lastly dropped. That is, Condition (6) defines that the number of riding users does not become zero except for a route, in which the taxi heads for the start point (depot), “s”. At present, by law, taxis are unable to generate fares when the taxis are vacant, and thus Condition (6) is a natural constraint. Condition (6) assures that the taxi does not become vacant except for when the taxi heads for the depot. By addition of this constraint of Condition (6), when the problem is treated as a vehicle routing problem, the fare is unable to be prevented from becoming more expensive than that in a case where the user uses the taxi alone, that is, subadditivity is unable to be assured.

When the subset X is specified and calculation is instructed, the cost calculating unit 41 refers to the cost database 32, and if a cost and a route corresponding to the specified subset X have been stored in the cost database 32, the cost calculating unit 41 replies the cost and route corresponding to the subset X. On the contrary, if the cost and route corresponding to the specified subset X have not been stored in the cost database 32, the cost calculating unit 41 solves the traveling salesman problem by calculating a route, by which the cost in Expression (2) is minimized under the constraint conditions expressed by the above described Conditions (3) to (6). The cost calculating unit 41 then replies the calculated cost and route. Further, the cost calculating unit 41 stores the cost and route into the cost database 32, in association with the specified subset X. Thereby, when the subset X, for which the cost and the route have been stored in the cost database 32, is specified, the cost calculating unit 41 is able to reply the cost and route without solving the traveling salesman problem again.

The partitioning unit 42 partitions users, from which requests for ride sharing have been received, and for which an operation plan is to be generated, into plural groups fulfilling subadditivity. For example, a set N={1, . . . , |N|} having elements that are the users, for which the operation plan is to be generated, is partitioned into subsets fulfilling subadditivity.

Techniques for partitioning the set N include a technique, in which the set N is partitioned into subsets without the elements being allowed to overlap, and a technique, in which the set N is partitioned into subsets by the elements being allowed to overlap. For example, by solving of a set partitioning problem, the set N is able to be partitioned into subsets without overlap of the elements being allowed. Further, by solving of a set covering problem, the set N is able to be partitioned into subsets with overlap of the elements being allowed. The set partitioning problem and the set covering problem are able to be expressed by Expression (7) below, as 0-1 integer linear optimization problems.

Herein, “L” indicates a family of subsets X of N. For a set partitioning problem, a portion 70 of Expression (7) is “ρε{=}”. For a set covering problem, the portion 70 of Expression (7) is “ρε{≧}”. Further, Expression (7-1) defines that the problem is a problem for minimizing the number of partitioned or covered subsets X. According to Expression (7-2), for a set partitioning problem (ρε{=}), the user, “i”, belongs to one subset X, and for a set covering problem (ρε{≧}), the user, “i”, belongs to at least one subset X. When a subset X is an element of L, a variable ξ(X), in Expression (7-3) is a variable that becomes “0” or “1”; and when the subset X is used, the variable ξ(X) becomes “1”, and when the subset X is not used, the variable ξ(X) becomes “0”.

Expression (7) is a problem for finding a combination of X with the minimum number of groups, from subsets of L, and for example, is able to be solved by use of a dedicated solver.

A specific example of the calculation will now be described. For example, it will be assumed that the sets N and L are as follows.

N={1, 2, 3, 4}

L={{2}, {4}, {1, 2, 4}, {1, 3}, {3, 4}}

In this case, from the respective subsets included in L, Expression (7-1) is derived into Expression (8-1) below. Further, Expression (7-2) is derived into Expressions (8-2) to (8-5). Furthermore, Expression (7-3) remains as it is as Expression (8-6).

$$min ξ ( \{ 2 \} ) + ξ ( \{ 4 \} ) + ξ ( \{ 1 , 2 , 4 \} ) + ξ ( \{ 1 , 3 \} ) + ξ ( \{ 3 , 4 \} ) … ( 8 - 1 )$$

$$s . t . ξ ( \{ 1 , 2 , 4 \} ) + ξ ( \{ 1 , 3 \} ) p 1 … ( 8 - 2 )$$

$$ξ ( \{ 2 \} ) + ξ ( \{ 1 , 2 , 4 \} ) p 1 … ( 8 - 3 )$$

$$ξ ( \{ 1 , 3 \} ) + ξ ( \{ 3 , 4 \} ) p 1 … ( 8 - 4 )$$

$$ξ ( \{ 4 \} ) + ξ ( \{ 1 , 2 , 4 \} ) + ξ ( \{ 3 , 4 \} ) p 1 … ( 8 - 5 )$$

$$ξ ∈ {\{ 0 , 1 \}}^{L} … ( 8 - 6 )$$

Expression (8-2) is the sum of ξ corresponding to the subsets, to which the user, “1”, belongs. Expression (8-3) is the sum of ξ corresponding to the subsets X, to which the user, “2”, belongs. Expression (8-4) is the sum of ξ corresponding to the subsets X, to which the user, “3”, belongs. Expression (8-5) is the sum of ξ corresponding to the subsets X, to which the user, “4”, belongs.

In this case, the optimum solution of the set partitioning problem is “{1, 3}, {2}, {4}”. The optimum solution in the set covering problem is, for example, “{1, 3}, {1, 2, 4}”.

In general, calculation for set covering problems are easier than that for set partitioning problems. However, in a set covering problem, overlap of elements is generated, and the same element may be included in plural subsets X. Thus, for example, the partitioning unit 42 finds the optimum solution by regarding the problem as a set covering problem. Any redundant element is deleted from the subsets X by the deleting unit 43 described later.

The 0, 1 optimization problem expressed by Expression (7) may be not solved in real time depending on complexity and scale of the problem. Thus, an optimization problem may be treated as a relaxation problem. For example, a relaxation problem, in which relaxation is continuously performed by replacement of ξ of a set covering problem expressed by Expression (7) from the variable taking “0” or “1” to a variable taking a non-negative real number, is able to be expressed by Expression (9) below.

$$LP ( L ) \vert \begin{matrix}min & {\sum }_{X ∈ L}^{ } ξ ( X ) & \\ s . t . & {\sum }_{X ∈ L ; i ∈ X}^{ } ξ ( X ) \geq 1 & ( i ∈ N ) \\ & ξ ∈ {R}_{+}^{L} & \end{matrix} \qquad ( 9 )$$

Expression (9) results from replacement of ξ in Expression (7) from the variable taking the integer “0” or “1”, to a variable taking a non-negative real number. Herein, R₊ represents the non-negative real number. The optimum value of the relaxation problem becomes a value that is better than the optimum value of the original optimization problem. Further, the relaxation problem is a continuous linear optimization problem, and calculation therefor is easier than that for the original optimization problem.

Further, a continuous linear optimization problem may be considered as a dual problem with a matching optimum value. For example, a relaxation problem expressed by Expression (9) is a problem viewed from a viewpoint of partitioning into optimum subsets, and when the relaxation problem is viewed from a user side viewpoint, the relaxation problem is able to be expressed as a dual problem as in Expression (10) below.

$$DP ( L ) \vert \begin{matrix}min & {\sum }_{i ∈ N}^{ } λ ( i ) & \\ s . t . & {\sum }_{i ∈ X}^{ } λ ( i ) \leq 1 & ( X ∈ L ) \\ & λ ∈ {R}_{+}^{N} . & \end{matrix} \qquad ( 10 )$$

Information on a variable λ(i), obtained as a result of solving of this dual problem is information corresponding to the user, “i”. The larger the value of λ(i) is, the higher the possibility that the element of the user, “i”, is suitable for achievement of optimum partitioning is. This dual problem is also able to be solved by, for example, use of a dedicated solver.

The partitioning unit 42 performs ordering of elements corresponding to users, “i”, of a set N, by using λ(i) as an index indicating a possibility that subadditivity is fulfilled. The partitioning unit 42 then determines whether a combination of elements, which are in descending order of the ordering sequence numbers, the number of the elements in the combination being equal to or less than a predetermined number, “m”, fulfills subadditivity. The partitioning unit 42 then partitions the set N into subsets X, for which ride sharing is to be operated, by adding the combination of elements fulfilling subadditivity to the subsets X. The predetermined number, “m”, is the upper limit number of people to be included in a subset X, and is set by a manager or the like appropriately, in consideration of the operation. For example, the predetermined number, “m”, may be the number of people that are able to ride a taxi or the like simultaneously.

The partitioning unit 42 finds, from subsets X fulfilling subadditivity, a combination of subsets X to be used in the operation. For example, the partitioning unit 42 solves the optimization problem of Expression (7) by regarding the family of subsets X fulfilling subadditivity as L, to find a combination of subsets X with the minimum number of subsets X. The method of finding the combination of subsets X to be used in the operation is not limited to this example, and any method may be used. The partitioning unit 42 may change the method of finding the combination of subsets X according to conditions of the operation. For example, if the number of operated taxis to be in operation has been determined, the partitioning unit 42 may find the combination of subsets X, such that the elements of the set N are included in any of the subsets X, by matching the number of partitioned subsets X with the number of operated taxis. Further, if users are assigned averagely, for example, a combination of subsets X may be found, such that elements of a set N are included in any of the subsets X, and the numbers of elements therein become about the same. Since each of the subsets X fulfills subadditivity, selection of any combination thereof is able to fulfill subadditivity.

As described above, when the partitioning unit 42 solves the optimization problem as a set covering problem, the elements may overlap among the plural subsets X.

When the elements overlap in the combination of subsets X found by the partitioning unit 42, the deleting unit 43 thus deletes any overlapping elements from each of the subsets X with overlapping elements, excluding any one of the subsets X. The subsets X, from which the overlapping elements are deleted, may be determined in any way. For example, the deleting unit 43 performs ordering of the subsets X in predetermined order, such as in ascending order of the numbers of elements therein. The deleting unit 43 may check, according to the ordering, for any overlap of elements with subsets X preceding in the order, and may delete any element overlapping that of the subset X preceding in the order. Further, for example, the deleting unit 43 may delete any overlapping elements from each of subsets X with overlapping elements, except for a subset X with the least number of elements. Furthermore, for example, the deleting unit 43 may find subsets X, from which any overlapping elements are to be deleted, such that the amount of sales (cost) of the operation company is maximized. In the following calculation of the cost, the combination of subsets X found by the partitioning unit 42 will each be denoted as a subset “Pⱼ (j=1, . . . , |P|).

For example, if deletion is performed such that the amount of sales of the operation company (the total of costs of users) is maximized, by solving of an optimization problem expressed by Expression (11) below, subsets X, from which the same elements are to be deleted, are able to be found.

$$\begin{matrix}min f ( \{ {x}_{ij} \} ) \} & … ( 11 - 1 ) \\ s . t . {\sum }_{j = 1}^{\vert P \vert} {x}_{ij} = 1 & ( i ∈ N ) \\ {x}_{ij} \leq {e}_{ij} & ( i ∈ N , j ∈ \{ 1 , … , \vert P \vert \} )\end{matrix} \} \qquad ( 11 )$$

In Expression (11-1), “f({xᵢⱼ})” is an objective function indicating the amount of sales. This “f({xᵢⱼ})” is, for example, a function for summing up the costs in the cost database 32 corresponding to the elements included in each of the subsets X with overlapping elements. By changing the subsets X, from which the elements are to be deleted, the subsets X, from which the elements are to be deleted, are found such that “f({xᵢⱼ})” is maximized. In the objective function, “f”, “xᵢⱼ(iεN, jε{1, . . . , |P|})” takes everything as arguments. Herein, “xᵢⱼ” is a variable that becomes “1” when the element of the user, “i”, belongs to the subset Pⱼ, and becomes “0” when the element does not belong to the subset Pⱼ. Further, “eᵢⱼ” is a constant that becomes “1” when the element of the user, “i”, belongs to the subset Pⱼ, and becomes “0” when this element does not belong to the subset Pⱼ, according to the result obtained by the partitioning. The deleting unit 43 outputs the subsets X, from which the overlapping elements have been deleted, as a result of the deletion. For example, the deleting unit 43 outputs “{{i|iεN, xᵢⱼ=1}, jε{1, . . . , |P|}}”, as the result of the deletion. The user, “i”, for which xᵢⱼ=1, will then belong to the j-th group.

Regardless of the combination of elements therein, a subset X partitioned by the partitioning unit 42 fulfills subadditivity. Thus, any combination of elements in a subset X, from which any element has been deleted by the deleting unit 43, also fulfills subadditivity. Further, the elements of the set N are all included in any of the subsets X without overlapping one another. Therefore, by division of users, for which an operation plan is to be generated, into groups corresponding to the respective subsets X, the users are divided into groups fulfilling subadditivity.

The generating unit 44 generates an operation plan by using the partitioned subsets X. If the elements overlap in a combination of subsets X found by the partitioning unit 42, the generating unit 44 generates an operation plan by using subsets X, from which the redundant elements have been deleted by the deleting unit 43. For example, for each of the subsets X, the generating unit 44 reads route information corresponding to the elements included in the subset X, from the cost database 32, and identifies the route. These subsets X fulfill subadditivity. Thus, the cost generated for the route of the route information is equal to or less than the total of individual costs generated respectively for the users corresponding to the elements of the subset X. That is, the generating unit 44 is able to generate an operation plan assuring subadditivity.

In this embodiment, for each of groups corresponding to the subsets X, subadditivity is assured, but a problem of how to distribute the cost (fare) to the users within the group remains.

Thus, for each of the groups corresponding to the subsets X, the cost recalculating unit 45 distributes the cost to the users by a distribution method, by which every user belonging to the group does not suffer a loss. For example, the cost recalculating unit 45 reads, for each of the subsets X, a cost value of each of the elements alone included in the subset X, from the cost database 32. Further, for example, the cost recalculating unit 45 reads an operation cost V(X) having all of the elements included in the subset X as a subset, from the cost database 32. The cost recalculating unit 45 then distributes the operation cost V(X) of the subset X as expressed by Expression (12) below.

$$\frac{V ( \{ i \} )}{{\sum }_{j ∈ X}^{ } V ( \{ j \} )} V ( X ) \qquad ( 12 )$$

Herein, V({i}) denotes a cost of the element, “i”, alone. Further, ΣV({j}) denotes the total of the individual costs of the respective elements of the subset X.

The notification unit 46 notifies the users, from which ride sharing has been requested, of the cost and the operation plan. For example, by the appointed day, on which the ride sharing operation is executed, based on the cost and the operation plan, the notification unit 46 causes the user terminal 12 of a user, from which a request for ride sharing has been received, to display an operation plan screen indicating the start point, start time, arrival point, and arrival time for the user.

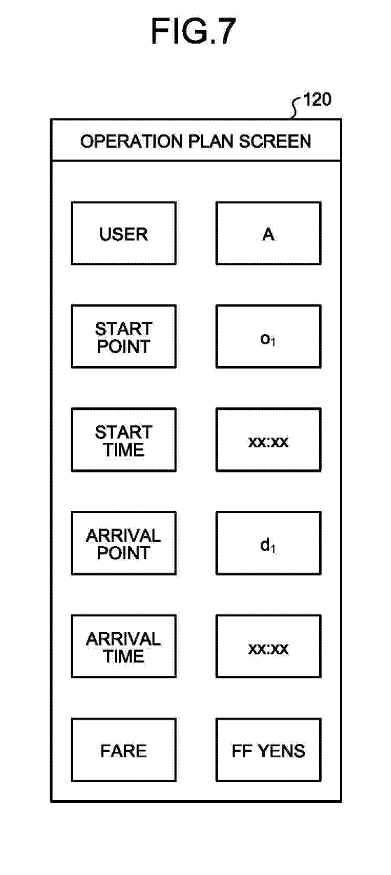

FIG. 7 is a diagram illustrating an example of the operation plan screen. The example in FIG. 7 illustrates an example of an operation plan screen displayed on the user terminal 12. On an operation plan screen 120, a start point, a start time, an arrival point, an arrival time, and a fare, are displayed. A user desiring the ride sharing operation is able to know the start time, the arrival time, and the fare, from the operation plan screen 120.

Flow of Processing

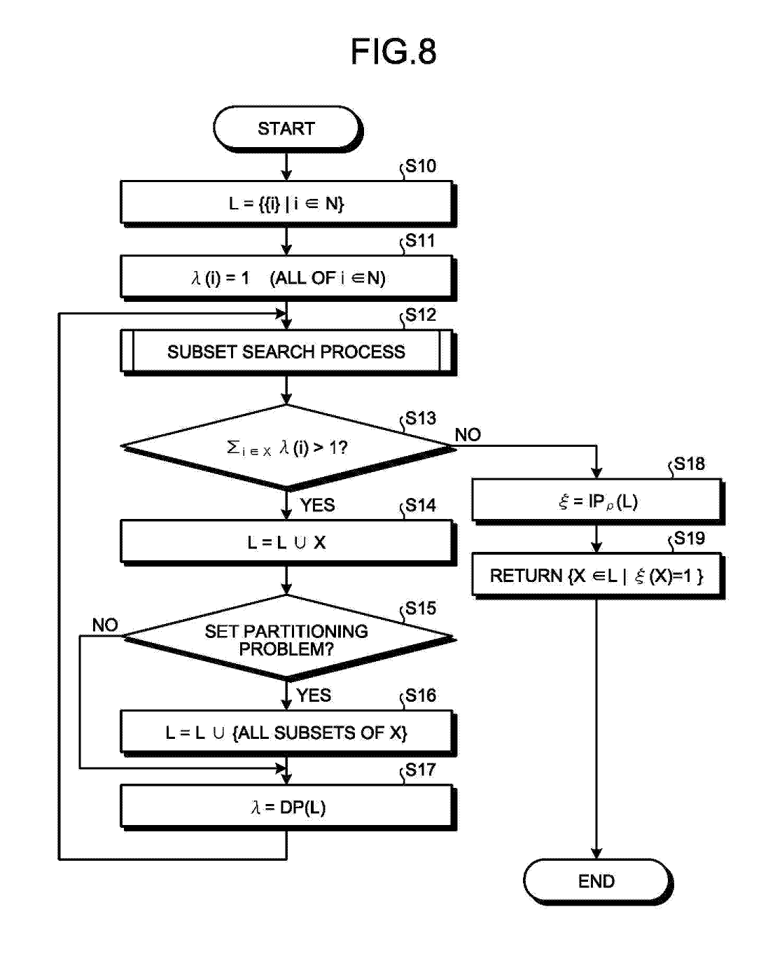

Next, a flow of various types of processing executed by the operation planning apparatus 11 according to the embodiment will be described. Firstly, a flow of a partitioning process, in which the partitioning unit 42 partitions users, from which requests for ride sharing have been received, and for which an operation plan is to be generated, into plural groups fulfilling subadditivity, will be described. FIG. 8 is a flow chart illustrating an example of a procedure of the partitioning process. This partitioning process is executed at a predetermined time, for example, when a predetermined process start time on a day before the desired date of ride sharing arrives, or when a manager instructs start of the process. Parameters used then will now be described. It will be assumed that a set having elements, which are users, for which an operation plan is to be generated, is a set N={1, . . . , |N|}. Further, V(X) denotes a cost for a subset X(X⊂N). Further, “m” denotes the upper limit number of people to be included in the subset X.

As illustrated in FIG. 8, the partitioning unit 42 adds each of the elements of the set N alone to L (S10). The partitioning unit 42 initializes all of indices λ(i) indicating highness of possibilities that subadditivity is fulfilled for the respective elements of the set N, to “1” (S11).

The partitioning unit 42 executes a subset search process, and finds subsets X fulfilling subadditivity (S12).

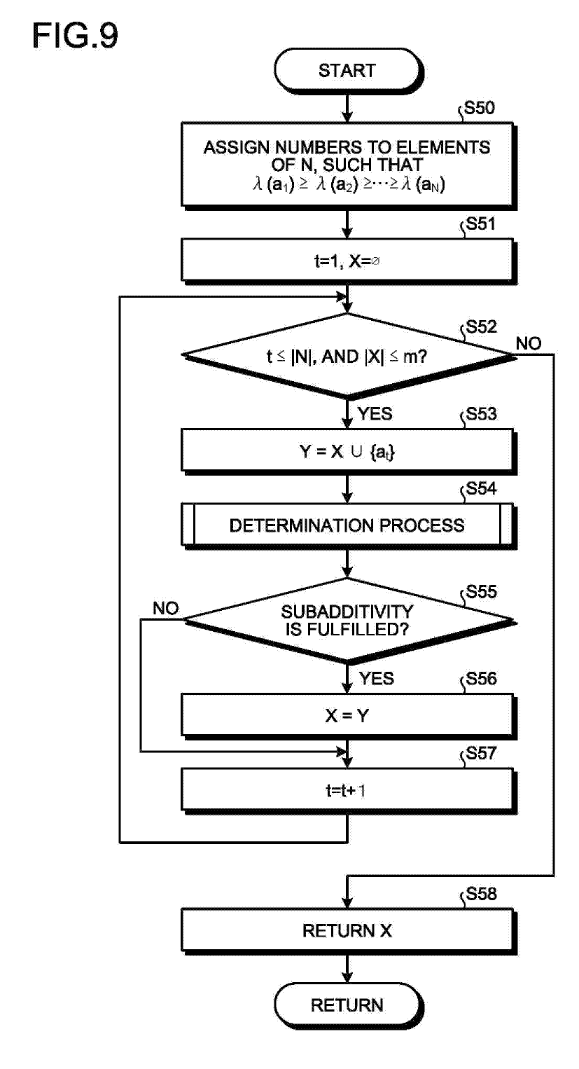

FIG. 9 is a flow chart illustrating an example of a procedure of the subset search process. This subset search process is executed from S12 of the partitioning process.

As illustrated in FIG. 9, the partitioning unit 42 performs ordering of elements, “i”, of the set N, by using the indices λ(i) (S50). For example, the partitioning unit 42 assigns numbers to the elements, “i”, of the set N, such that λ(a1)≧λ(a2) . . . MX (aN). When the subset search process is executed for the first time, since all of the indices λ(i) have been initialized to “1”, the elements, “i”, are assigned with the numbers in the order of the customer numbers, for example. When the subset search process is executed for the second time or later, since the indices λ(i) are updated in later described processing at S17, the elements, “i”, are assigned with the numbers in descending order of the indices λ(i).

The partitioning unit 42 sets the variable, “t”, to “1”, and initializes a subset X to be vacant (S51). The partitioning unit 42 determines whether the value of the variable, “t”, is equal to or less than the number of elements of the set N, “|N|”, and the number of elements of the subset X, “|X|”, is equal to or less than “m” (S52).

If the determination at S52 is affirmative (S52; Yes), the partitioning unit 42 determines a set of the sum of the subset X and the element of the number, “t”, as a subset Y (S53). The partitioning unit 42 executes a determination process, in which whether the combination of the elements of the subset Y fulfills subadditivity (S54).

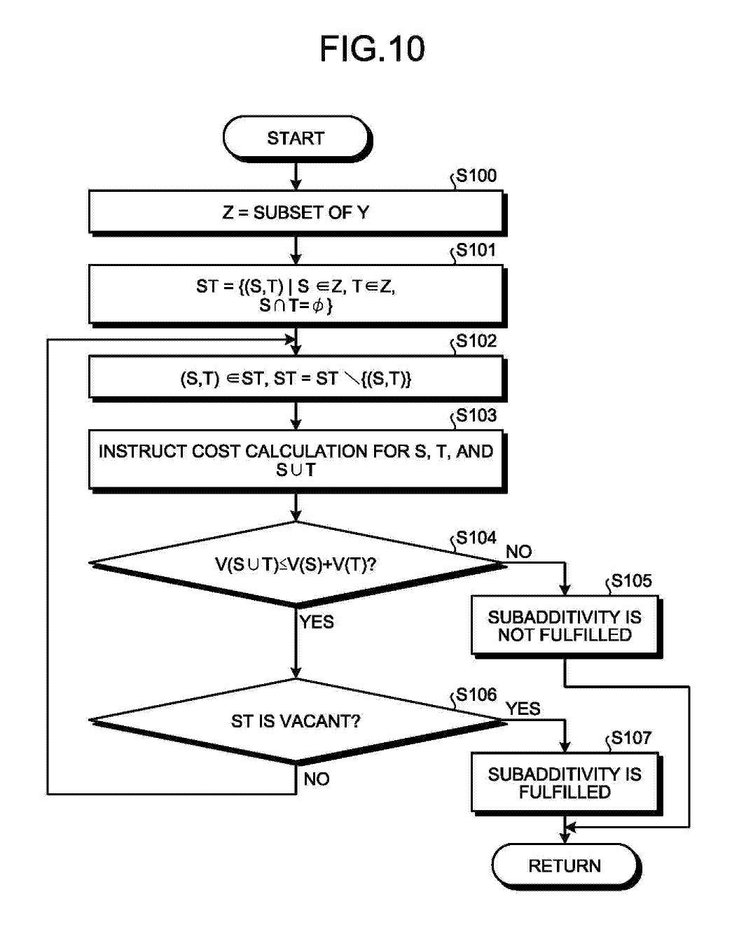

FIG. 10 is a flow chart illustrating an example of a procedure of the determination process. This determination process is executed from S54 of the subset search process.

As illustrated in FIG. 10, the partitioning unit 42 finds a subset Z for each combination of elements of the subset Y (S100). The partitioning unit 42 finds a set ST, which is a combination of sets having no elements in common, from the respective subsets Z (S101). That is, the partitioning unit 42 divides the subset Y into the set ST, which is a combination of all of subsets with no common elements.

The partitioning unit 42 takes out arbitrary elements (S, T) from the set ST, and deletes the elements (S, T) from the set ST (S102).

The partitioning unit 42 instructs the cost calculating unit 41 to execute calculation, with each of S, T, and S∪T being a subset X (S103). If costs and routes corresponding to the specified subsets X have been stored in the cost database 32, the cost calculating unit 41 replies the costs and routes corresponding to the subsets X. On the contrary, if the costs and routes corresponding to the specified subsets X have not been stored in the cost database 32, the cost calculating unit 41 calculates and replies the costs and routes. Further, the cost calculating unit 41 stores the costs and routes into the cost database 32, in association with the specified subsets X.

The partitioning unit 42 determines whether the elements S and T fulfill subadditivity (S104). For example, the partitioning unit 42 determines whether the total of the individual costs V(S) and V(T) of the respective elements S and T, is equal to or larger than the cost of ride sharing between the elements S and T, “V(S∪T)”.

If subadditivity is not fulfilled (S104; No), the partitioning unit 42 determines that subadditivity is not satisfied (determines the result of the determination as “false”) (S105), ends the determination process, and proceeds to S55 of FIG. 9.

If subadditivity is fulfilled (S104; Yes), the partitioning unit 42 determines whether or not the set ST has become vacant (S106). If the set ST is not vacant (S106; No), the process is advanced to the above described S102, and the test for subadditivity is executed for the next element.

On the contrary, if the set ST is vacant (S106; Yes), since the combination of elements of the subset Y fulfills subadditivity, the partitioning unit 42 determines that subadditivity is fulfilled (determines the result of the determination as “true”) (S107), ends the determination process, and proceeds to S55 of FIG. 9.

As illustrated in FIG. 9, the partitioning unit 42 determines whether or not subadditivity has been determined to be fulfilled, by the determination process (the determination result is “true”) (S55). If the determination result indicating that subadditivity has been satisfied is not able to be obtained (S55; No), the process is advanced to later described S57.

If the determination result indicating that subadditivity is fulfilled is able to be obtained (S55; Yes), the partitioning unit 42 stores the elements of the subset Y in the subset X (S56). The partitioning unit 42 adds “1” to the value of the variable, “t” (S57), and proceeds to the above described S52.

On the contrary, if the determination of S52 is not affirmative (S52; No), the partitioning unit 42 replies the subset X (S58), ends the subset search process, and proceeds to S13 of FIG. 8.

As illustrated in FIG. 8, the partitioning unit 42 determines whether or not the total of indices λ, of the elements included in the subset X obtained as the reply is larger than “1” (S13). When the subset search process is executed for the first time, since all of the indices λ(i) have been initialized to “1”, if the number of elements in the subset X is equal to or larger than “2”, the total of the indices λ, of the elements included in X, is determined to be larger than “1”.

The partitioning unit 42 adds the subset X to L (S14). The partitioning unit 42 determines whether partitioning is being executed as a set partitioning problem (S15). If partitioning is being executed as a set covering problem, instead of a set partitioning problem (S15; No), the partitioning unit 42 proceeds to later described S17.

On the contrary, if partitioning is being performed as a set partitioning problem (S15; Yes), the partitioning unit 42 adds all of subsets for the elements included in the subset X to L (S16). By using a dedicated solver, the partitioning unit 42 solves the above described Expression (10), recalculates an index λ(i), indicating highness of a possibility that subadditivity is fulfilled, for each of the elements of the set N (S17), and proceeds to the above described S12. As to the index λ(i), by the subset X being determined, subsequently, the index λ(i) corresponding to an element suitable for suitable partitioning is increased.

On the contrary, if the total of the indices λ(i), of the elements included in the subset X is not larger than “1” (S13; No), for example, the partitioning unit 42 solves the optimization problem of Expression (7), and finds a combination of subsets X, for which the number of subsets X becomes the smallest, from the subsets X included in L (S18). The partitioning unit 42 replies the combination of subsets X, for which the number of subsets X becomes the smallest, as a result of the partitioning (S19), and ends the process.

The partitioning unit 42 limits, as illustrated in S52 of FIG. 9, the number of elements in the subset X, “|X|”, to a range of equal to or less than “m”. The partitioning unit 42 then calculates the cost V, for only the subsets of Y. Thereby, since the number of combinations is prevented from becoming large in the determination process of whether the combinations of elements of the subsets X fulfill subadditivity, the amount of calculation is able to be reduced. Further, if the value of “m” is made small, since the amount of calculation will not be explosively increased in the determination process of whether subadditivity is fulfilled, the solution is able to be obtained in real time.

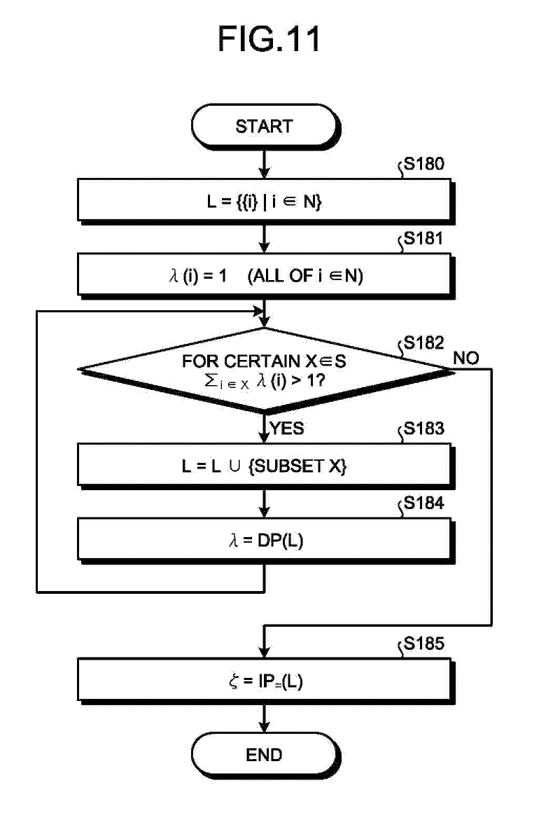

Description will now be made by use of a comparative example. FIG. 11 is a flow chart illustrating an example of a procedure of a partitioning process to be compared. Parameters used therefor will now be explained. A set having elements that are users, for which an operation plan is to be generated, is denoted as a set N={1, . . . , |N|}. Further, V(X) denotes a cost corresponding to a subset X(X⊂N). Further, S is a family of subsets of N, and fulfills subadditivity.

As illustrated in FIG. 11, the partitioning unit 42 adds each of elements of the set N alone to L (S180). The partitioning unit 42 initializes all of indices λ(i), each indicating highness of a possibility of subadditivity being satisfied, for the respective elements of the set N, to “1” (S181).

For a subset X included in S, the partitioning unit 42 determines whether or not the total of indices λ of elements included in the subset X is larger than “1” (S182). If the total of indices λ is larger than “1” (S182; Yes), the partitioning unit 42 adds the subset X to L (S183). By using a dedicated solver, the partitioning unit 42 solves the above described Expression (10) to recalculate an index λ(i) indicating highness of a possibility of subadditivity being satisfied, for each of the elements of the set N (S184), and proceeds to the above described S182.

On the contrary, if the total of the indices λ of the elements included in the subset X is not larger than “1” (S182; No), for example, the partitioning unit 42 solves the optimization problem of Expression (7), and finds a combination of subsets X, for which the number of subsets X becomes the smallest, from the subsets X included in L (S185), and ends the process.

For example, without limiting the number of elements |X| of the subset X to the range of equal to or less than “m”, the partitioning unit 42 partitions the set N into subsets X like for the partitioning process for the target to be compared illustrated in FIG. 11. In this case, in association with the increase in the number of elements |N| of the set N, the amount of calculation increases explosively. For example, in order to find the cost V(X) for the subset X, 2^{N} cost calculations for combinations of elements of the set N will be needed. Further, in order to find S, 3^{N} calculations will be needed.

On the contrary, in the partitioning process according to this embodiment, as illustrated in S52 of FIG. 9, by limitation of the number of elements |X| of the subset X to the range of equal to or less than “m”, the increase in the amount of calculation is able to be reduced.

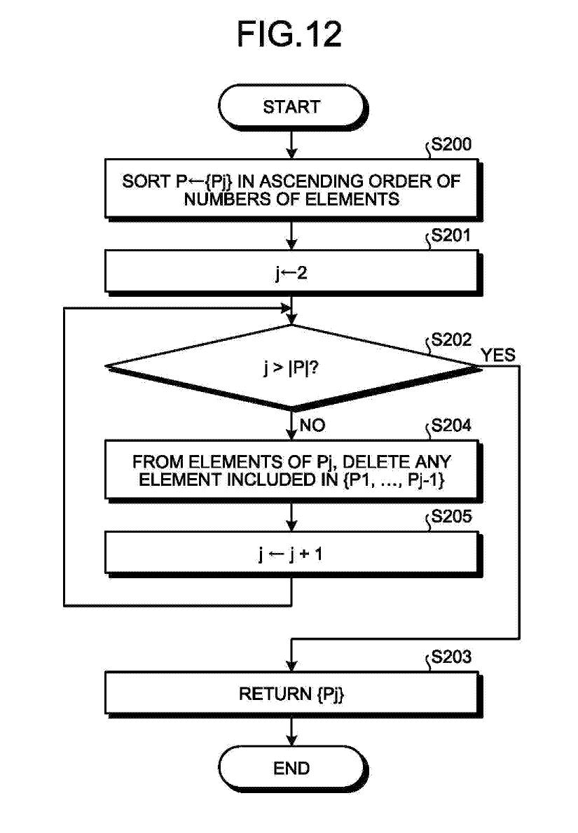

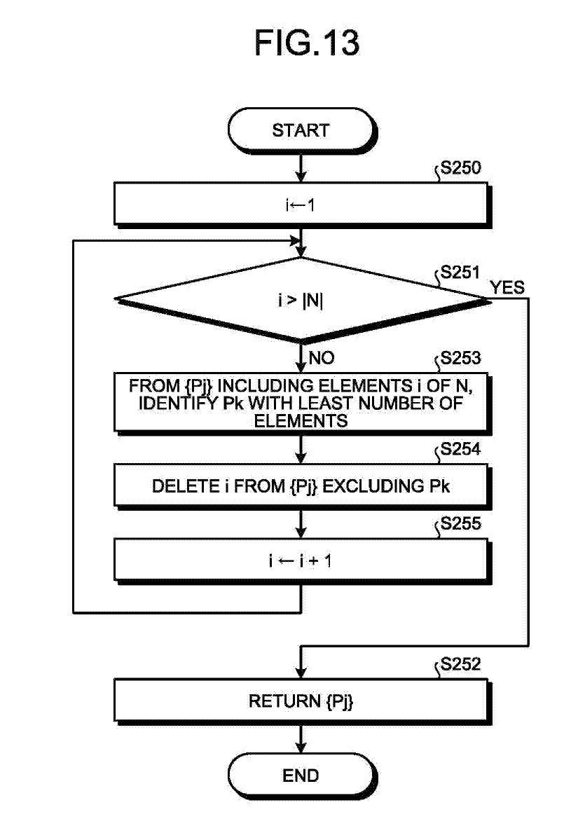

Next, a flow of a deletion process, in which the partitioning unit 42 deletes any redundant elements from subsets X, will be described. FIG. 12 is a flow chart illustrating an example of a procedure of the deletion process. This deletion process is executed at a predetermined time, for example, when a combination of subsets X is obtained by the partitioning unit 42 as a set covering problem, or when a manager instructs the process to be started. In FIG. 12 and later described FIG. 13, each subset X in a combination of subsets X obtained as a set covering problem will be denoted as a subset Pⱼ (j=1, . . . , |P|).

As illustrated in FIG. 12, the deleting unit 43 sorts the subsets Pⱼ in ascending order of the numbers of elements thereof (S200). The deleting unit 43 sets “j” to “2” (S201). The deleting unit 43 determines whether or not the value of “j” is larger than |P| (S202). If the value of “j” is larger than |P| (S202; Yes), the deleting unit 43 replies, as a deletion result, the subset Pⱼ (j=1, . . . , |P|) (S203), and ends the process.

On the contrary, if the value of “j” is not larger than |P| (S202; No), the deleting unit 43 deletes any element, from elements included in the subset Pⱼ, the element overlapping that of subsets P₁, . . . , Pⱼ₋₁, that are before the subset Pⱼ in the order (S204). The deleting unit 43 adds “1” to the value of “j” (S205), and proceeds to the above described S202.

Next, another example of the deletion process will now be described. FIG. 13 is a flow chart illustrating another example of the procedure of the deletion process.

As illustrated in FIG. 13, the deleting unit 43 sets “i” to “1” (S250). The deleting unit 43 determines whether or not the value of “i” is larger than |N| (S251). If the value of “i” is larger than |N| (S251; Yes), the deleting unit 43 replies, as a deletion result, the subsets Pⱼ (j=1, . . . , |P|) (S252), and ends the process.

On the contrary, if the value of “i” is not larger than |N| (S251; No), the deleting unit 43 identifies, from the subsets Pᵢ including the elements, “i”, included in the set N, a subset Pₖ with the least number of elements (S253). If there are plural subsets Pₖ with the least number of elements, the deleting unit 43 identifies a subset Pₖ with the least index, “k”.

The deleting unit 43 deletes the elements, “i”, from the subsets Pᵢ excluding the identified subset Pₖ(S254). The deleting unit 43 adds “1” to the value of “i” (S255), and proceeds to the above described S251.

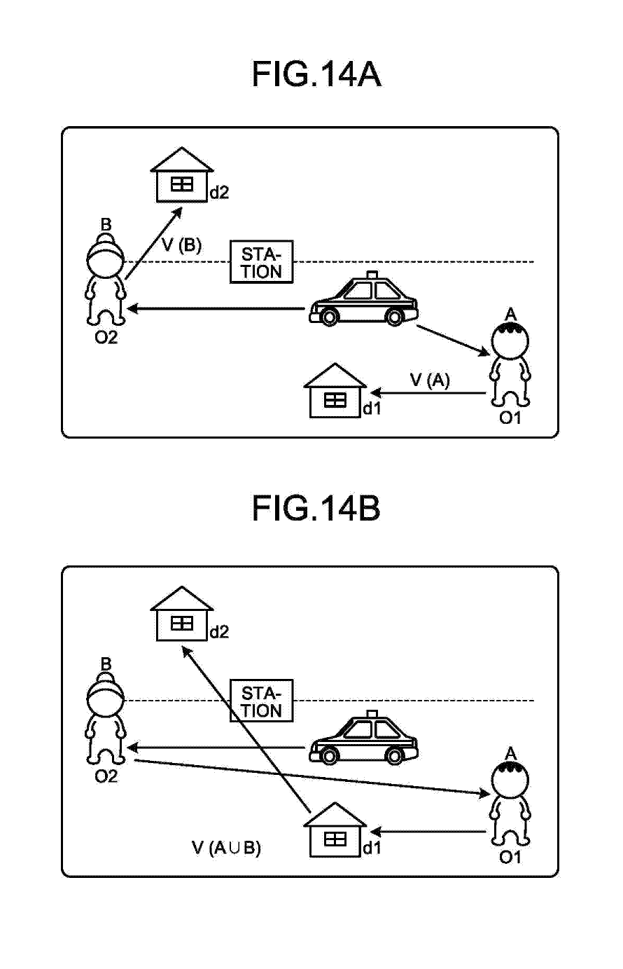

Next, by use of specific examples, generation of an operation plan by the operation planning apparatus 11 according to the embodiment will be described. FIG. 14A and FIG. 14B are diagrams illustrating the specific example. In FIG. 14A and FIG. 14B, users A and B are illustrated. For the user A, it is assumed that the start point is “o1” and the arrival point is “d1”. For the user B, it is assumed that the start point is “o2” and the arrival point is “d2”. When the operation planning apparatus 11 receives requests for ride sharing from the users A and B, the operation planning apparatus 11 calculates costs V(A) and V(B) for a case where operation is performed for each of the users A and B alone, and a cost V(A∪B) for a case where the users A and B share a ride. The cost V(A) is a cost of a route, “start point o1→arrival point d1”. The cost V(B) is a cost of a route, “start point o2→arrival point d2”. The cost V(A∪B) is a cost of a route, “start point o2→start point o1→arrival point d1→arrival point d2”. In the example of FIG. 14A and FIG. 14B, since V(A∪B)>V(A)+V(B), subadditivity is not satisfied. The operation planning apparatus 11 partitions the users into plural groups that fulfill subadditivity. In the example of FIG. 14A and FIG. 14B, the operation planning apparatus 11 does not put the user A and user B in the same group, and divides them into separate groups. The operation planning apparatus 11 generates a route of an operation plan for each of these groups. For example, as illustrated in FIG. 14A, the operation planning apparatus 11 generates operation plans for “start point o1→arrival point d1”, and “start point o2→arrival point d2”, by treating each of the user A and the user B as an independent group. Even in this case, when the users A and B request ride sharing, the fare therefor will not become more expensive than that for a case where each of the users A and B uses a taxi alone. As described above, even if ride sharing is requested, since the fare therefor will not become more expensive than that for the case where each of the users A and B uses a taxi alone, the users A and B are able to request ride sharing at ease.

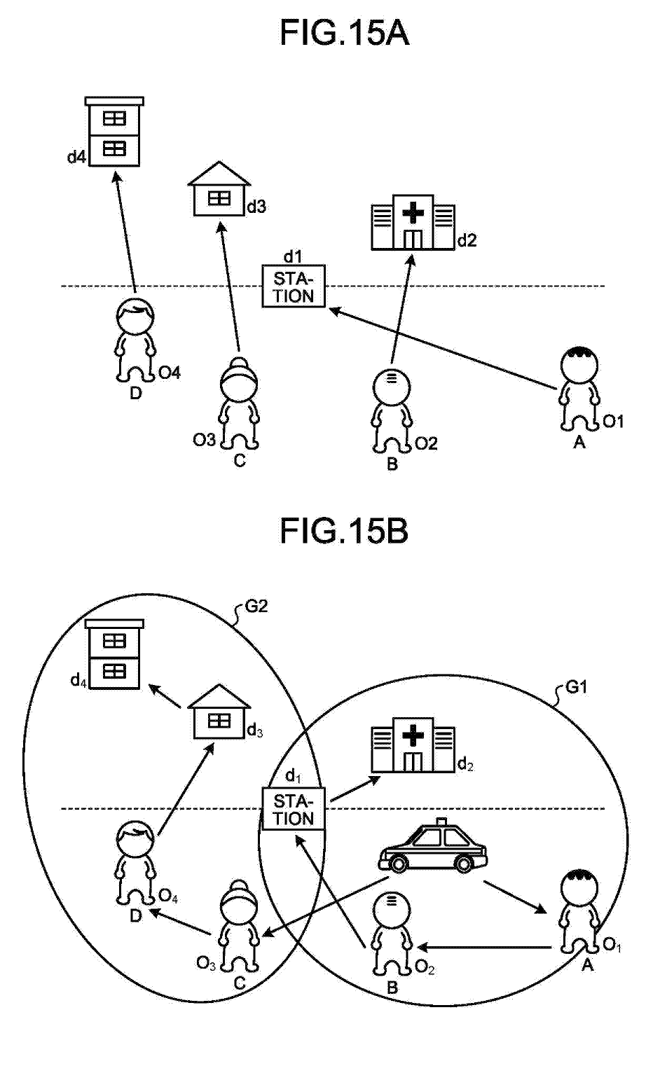

FIG. 15A and FIG. 15B are diagrams illustrating another specific example. In FIG. 15A and FIG. 15B, users A, B, C, and D are illustrated. For the user A, it is assumed that the start point is “o1” and the arrival point is “d1”. For the user B, it is assumed that the start point is “o2” and the arrival point is “d2”. For the user C, it is assumed that the start point is “o3” and the arrival point is “d3”. For the user D, it is assumed that the start point is “o4” and the arrival point is “d4”. When the operation planning apparatus 11 receives requests for ride sharing from the users A, B, C, and D, the operation planning apparatus 11 partitions the users A, B, C, and D into plural groups fulfilling subadditivity. In the example of FIG. 15A and FIG. 15B, the operation planning apparatus 11 partitions them into a group G1 of the users A and B, and a group G2 of the users C and D. The operation planning apparatus 11 then generates a route of an operation plan for each of these groups. In the example of FIG. 15A and FIG. 15B, the operation planning apparatus 11 generates a route for the group G1 as “start point o1→start point o2→arrival point d1→arrival point d2”. Further, the operation planning apparatus 11 generates a route for the group G2 as “start point o3→start point o4→arrival point d3→arrival point d4”. As described above, by the determination of the route for each of the groups fulfilling subadditivity, the users A, B, C, and D are able to use a taxi with a fare less expensive than that for a case where each of the users A, B, D, and D uses a taxi alone.

Effects

As described above, for a set N having elements that are users, for which a plan of operation including ride sharing is to be generated, the operation planning apparatus 11 according to the embodiment performs ordering of the elements of the set N by using indices indicating highness of possibilities of subadditivity being fulfilled. The operation planning apparatus 11 determines whether a combination of elements in descending order of the ordering fulfills subadditivity, the number of the elements in the combination being equal to or less than a predetermined number. The operation planning apparatus 11 partitions the set into subsets, by adding the combination of elements fulfilling subadditivity to the subsets, for which ride sharing is to be operated. The operation planning apparatus 11 then generates an operation plan by using the partitioned subsets. Thereby, the operation planning apparatus 11 is able to form an operation plan ensuring subadditivity with the amount of calculation being reduced.

Further, the operation planning apparatus 11 according to the embodiment partitions the set into subsets by allowing overlap of elements, by treating the problem as a set covering problem. The operation planning apparatus 11 deletes any overlapping elements from each of subsets with overlapping elements, excluding any one of the subsets. In general, the amount of calculation for a set covering problem is less than that for a set partitioning problem, and thus calculation for the set covering problem is easier. Thus, the operation planning apparatus 11 is able to reduce the amount of calculation by treating the problem as a set covering problem, partitioning the set into subsets by allowing overlap of elements, and deleting any overlapping elements from the subsets excluding one of the subsets.

Further, for each subset, the operation planning apparatus 11 according to the embodiment distributes the operation cost of the subset to each of elements belonging to the subset, according to the ratios of the individual operation costs of the elements to the total of the individual operation costs of the elements. Thereby, the operation planning apparatus 11 is able to distribute the cost for ride sharing to each user appropriately, with the cost being reduced, such that the cost for each user in ride sharing is less expensive than a cost for individual operation.

[b] Second Embodiment

Although the embodiment related to the disclosed apparatus has been described above, the disclosed techniques may be implemented in various different modes, in addition to the above described embodiment. Therefore, hereinafter, other embodiments included in the present invention will be described.

For example, in the above described embodiment, the case where the operation planning apparatus 11 generates an operation plan for a taxi to be shared has been described as an example. However, the present invention is not limited to this example. The operation planning apparatus 11 may generate an operation plan for a bus to be shared, or for when the same truck is used by plural customers according to a delivery plan.

Further, in the above described embodiment, a case where an operation plan is generated in consideration of conditions including a start point and an arrival point of each user has been described as an example. However, the present invention is not limited to this example. For example, an operation plan may be generated in consideration of conditions also including a desired start time and a desired arrival time of each user. For example, by addition of a desired start time and a desired arrival time of each user to constraint conditions of an optimization problem, partitioning into subsets satisfying the desired start times and the desired arrival times and fulfilling subadditivity is achieved, and thus an operation plan in consideration of a desired start time and a desired arrival time of each user is able to be generated.

Further, in the above described embodiment, a case where λ(i) is used as an index indicating highness of a possibility of subadditivity being fulfilled has been described as an example. However, the present invention is not limited to this example. Any index may be used, as long as the index indicates highness of a possibility that the element fulfills subadditivity. For example, by treating any of the users as a reference, proximity of a start point and an arrival point of another user to a start point and an arrival point of the user treated as the reference may be found, and the proximity may be used as the index indicating highness of the possibility that subadditivity is fulfilled. If there is no user with the proximity being equal to or larger than a predetermined proximity, by changing the user to be the reference, users with high proximities are able to be separated into the same group. The closer the distance between the start points and the distance between the arrival points are, the higher the proximity may be found to be, for example. Further, for example, a targeted range where ride sharing operation is performed may be divided into areas each having a certain size, and the number of areas between the start points and the number of areas between the arrival points may be used as the proximity. In this case, the smaller the number of areas is; the higher the proximity is, and the higher the possibility that subadditivity is fulfilled is.

Further, in the above described embodiment, the case where the partitioning unit 42 initializes the initial value of λ(i) of each element to “1” has been described as an example. However, the present invention is not limited to this example. For example, instead of the initialization, the partitioning unit 42 may calculate an index λ(i) indicating highness of a possibility that subadditivity is satisfied for each element of a set N from the beginning.

Further, each component of the respective devices in the drawings has been functionally and conceptionally illustrated, and does not need to be configured physically as illustrated in the drawings. That is, a specific mode of separation and integration of the respective devices is not limited to those illustrated in the drawings, and all or a part thereof may be configured to be functionally or physically separated or integrated in arbitrary units depending on various loads and use situations. For example, any of respective processing units including the receiving unit 40, the cost calculating unit 41, the partitioning unit 42, the deleting unit 43, the generating unit 44, the cost recalculating unit 45, and the notification unit 46 may be integrated together, as appropriate. Further, processing of each of the processing units may be separated into processing of plural processing units, as appropriate. Further, all of or any part of the respective processing functions executed in the respective processing units may be realized by a CPU and a program analyzed and executed by the CPU, or may be realized as hardware by wired logic.

Operation Planning Program

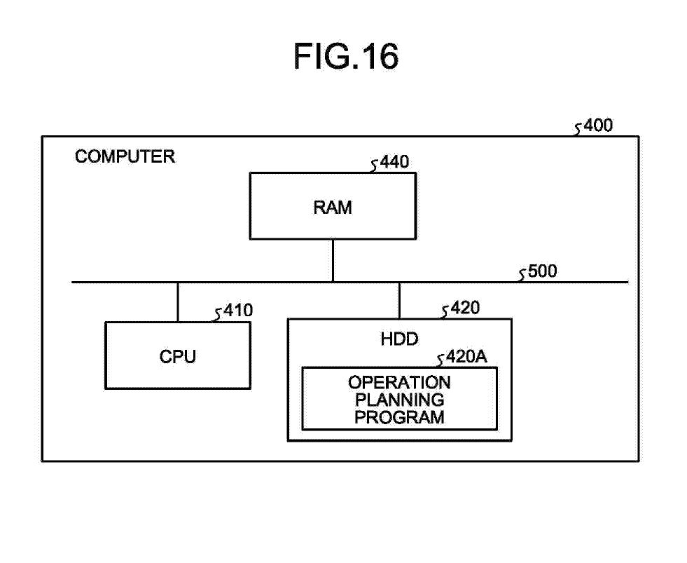

Various types of processing described in the above described embodiments may be realized by a program that has been prepared in advance, the program being executed by a computer system, such as a personal computer or a work station. Thus, hereinafter, an example of a computer system that executes an operation planning program that assists in operation will be described. FIG. 16 is a diagram illustrating an example of a configuration of a computer that executes the operation planning program.

As illustrated in FIG. 16, a computer 400 has a central processing unit (CPU) 410, a hard disk drive (HDD) 420, and a random access memory (RAM) 440. These units 400 to 440 are connected to one another via a bus 500.

In the HDD 420, an operation planning program 420A, which executes the same functions as the receiving unit 40, the cost calculating unit 41, the partitioning unit 42, the deleting unit 43, the generating unit 44, the cost recalculating unit 45, and the notification unit 46, which have been described above, is stored in advance. The operation planning program 420A may be separated, as appropriate.

Further, the HDD 420 stores therein various pieces of information. For example, the HDD 420 stores therein, similarly to the storage unit 21, an OS and various data to be used in assisting the operation.

By the CPU 410 reading and executing the operation planning program 420A from the HDD 420, operation that is the same as that of the respective processing units of the embodiment is executed. That is, the operation planning program 420A executes the same operation as the receiving unit 40, the cost calculating unit 41, the partitioning unit 42, the deleting unit 43, the generating unit 44, the cost recalculating unit 45, and the notification unit 46.

The above described operation planning program 420A does not need to be stored in the HDD 420 from the beginning. Further, for example, the operation planning program 420A may be stored in a “portable physical medium”, such as a flexible disk (FD), a CD-ROM, a DVD disk, a magneto-optical disk, or an IC card, which is inserted in the computer 400. The computer 400 may read and execute the program therefrom.

Further, the program may be stored in “another computer (or server)” that is connected to the computer 400 via a public network, the Internet, a LAN, a WAN, or the like. The computer 400 may read and execute the program therefrom.

According to an embodiment of the present invention, an effect that an operation plan assuring subadditivity is able to be formed with the amount of calculation being reduced is achieved.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing an operation planning program that causes a computer to execute a process comprising:
for a set including elements that are users, for which a plan of operation including ride sharing is to be generated, performing ordering of the elements of the set by using indices indicating highness of possibilities that subadditivity is fulfilled, determining whether a combination of the elements in descending order of the ordering fulfills the subadditivity, the number of the elements in the combination being equal to or less than a predetermined number, and partitioning the set into subsets, for which the ride sharing is to be operated, by adding the combination of elements fulfilling the subadditivity to the subsets; and
generating the plan of operation by using the partitioned subsets.

2. The non-transitory computer-readable recording medium according to claim 1, wherein
the partitioning includes treating the partitioning as a set covering problem and partitioning the set into the subsets by allowing overlap of the elements, and
the operation planning program causes the computer to further execute, from each of the subsets including the overlapping elements, deleting the overlapping elements except for any one of the subsets.

3. The non-transitory computer-readable recording medium according to claim 1, wherein the operation planning program causes the computer to further execute, for each of the subsets, distributing an operation cost of the subset to each of the elements belonging to the subset, according to ratios of individual operation costs of the elements to the total of the individual operation costs of the elements.

4. An operation planning method comprising:
for a set including elements that are users, for which a plan of operation including ride sharing is to be generated, performing ordering of the elements of the set by using indices indicating highness of possibilities that subadditivity is fulfilled, determining whether a combination of the elements in descending order of the ordering fulfills the subadditivity, the number of the elements in the combination being equal to or less than a predetermined number, and partitioning the set into subsets, for which the ride sharing is to be operated, by adding the combination of elements fulfilling the subadditivity to the subsets, by a processor; and
generating the plan of operation by using the partitioned subsets, by the processor.

5. An operation planning apparatus comprising:
a processor configured to:
for a set including elements that are users, for which a plan of operation including ride sharing is to be generated, perform ordering of the elements of the set by using indices indicating highness of possibilities that subadditivity is fulfilled, determine whether a combination of the elements in descending order of the ordering fulfills the subadditivity, the number of the elements in the combination being equal to or less than a predetermined number, and partition the set into subsets, for which the ride sharing is to be operated, by adding the combination of elements fulfilling the subadditivity to the subsets; and
generate the plan of operation by using the subsets partitioned.

6. An operation planning system comprising:
a terminal device that requests for ride sharing; and
an operation planning apparatus that includes:
a processor configured to:
for a set including elements that are users, for which a plan of operation including ride sharing is to be generated, perform ordering of the elements of the set by using indices indicating highness of possibilities that subadditivity is fulfilled, determine whether a combination of the elements in descending order of the ordering fulfills the subadditivity, the number of the elements in the combination being equal to or less than a predetermined number, and partition the set into subsets, for which the ride sharing is to be operated, by adding the combination of elements fulfilling the subadditivity to the subsets; and
generate the plan of operation by using the subsets partitioned.
